(19) United States
(12) Patent Application Publication
(10) Pub. No.: US 2026/0328308 A1
(43) Pub. Date: Oct. 22, 2026

(54) SOLENOID VALVE AND ASSEMBLY METHOD THEREOF

(71) Applicant: HL MANDO CORPORATION, Pyeongtaek-si (KR)

(72) Inventor: Minseong KIM, Pyeongtaek-si (KR)

(73) Assignee: HL MANDO CORPORATION, Pyeongtaek-si (KR)

(21) Appl. No.: 19/380,729

(22) Filed: Nov. 5, 2025

(30) Foreign Application Priority Data
Apr. 17, 2025 (KR) 10-2025-0050040

(51) Int. Cl. F16K 31/06

(52) U.S. Cl. CPC F16K 31/0675

(57) ABSTRACT

A solenoid valve comprises a bobbin having a wound coil and a ground terminal, wherein the ground terminal is integrally formed with bobbin; and a valve assembly configured to open or close a flow path by magnetic field generated by the wound coil, wherein a first end of the ground terminal is configured to be in contact with the valve assembly.

### CROSS-REFERENCE TO RELATED APPLICATIONS

This application claims the benefit of Korean Patent Application No. 10-2025-0050040, filed on Apr. 17, 2025 in the Korean Intellectual Property Office, the disclosure of which is incorporated herein by reference.

### BACKGROUND

### Field

The present invention relates to a solenoid valve and assembly method thereof.

### Description of the Related Art

The brake system is an essential component of a vehicle for deceleration, and it may include solenoid valves capable of controlling the hydraulic pressure delivered to the brakes of each wheel of the vehicle in order to manage braking. In particular, multiple solenoid valves are essential in electronically controlled brake systems because precise control of hydraulic pressure is important.

Conventional solenoid valves have employed one of two grounding techniques. The two grounding techniques include a first technique, in which the ground is provided on the housing of the solenoid valve so that it makes contact between the printed circuit board and the solenoid valve, and a second technique, in which the ground is mounted on the printed circuit board using surface mount technology (SMT) so that it makes contact between the printed circuit board and the solenoid valve.

The first technique has the disadvantage of requiring assembly work and reducing grounding performance due to the small contact area.

The second technique takes up a lot of space on the printed circuit board, and may require moving the grounding location and adding a grounding section to secure EMC (Electromagnetic Compatibility) performance, but there has been a problem that it is difficult to move or add the grounding location after the printed circuit board design is complete.

### SUMMARY

One aspect of the present disclosure is to provide a solenoid valve with a new structure in which a ground terminal is integrated with a bobbin of a solenoid coil and a method of assembling the same.

For example, the solenoid valve and the assembly method thereof according to the embodiment of the present disclosure can solve problems such as the occurrence of assembly man-hours, reduction of ground performance, space occupancy problem on printed circuit board, and difficulty in changing the ground position on printed circuit boards when applying the conventional solenoid valve ground technology.

According to one aspect of the present disclosure, there is provided a solenoid valve comprising: a bobbin having a wound coil and a ground terminal, wherein the ground terminal is integrally formed with the bobbin; and a valve assembly configured to open or close a flow path by magnetic field generated by the wound coil, whereina first end of the ground terminal is configured to be in contact with the valve assembly.

The ground terminal integrally formed with the bobbin may be formed in a pin shape on the bobbin.

The first end of the ground terminal integrally formed with the bobbin may be plated with gold or silver.

One side of the first end of the ground terminal integrally formed with the bobbin may have a linear shape, a curved shape, or a ring shape.

The solenoid valve may further comprise a circuit board configured to supply current to the wound coil.

A second end of the ground terminal integrally formed with the bobbin may be coupled to the circuit board.

The second end of the ground terminal integrally formed with the bobbin may be coupled to a ground terminal of the circuit board through press-fit or soldering.

The ground terminal integrally formed with the bobbin may extend in a straight line from the bobbin to the circuit board.

The ground terminal integrally formed with the bobbin may extend in a first straight line from the bobbin toward the circuit board, then extends in a horizontal direction, and then extends in a second straight line from the bobbin to the circuit board.

The bobbin may comprise a bobbin body having a hollow disk shape, and a bobbin protrusion configured to protrude by extending from a lower side of the bobbin body part.

The solenoid valve may further comprise a housing in which the bobbin is accommodated, wherein a lower surface of the housing is configured to be penetrated by the bobbin protrusion.

The ground terminal integrally formed with the bobbin may be integrally formed by being continuously connected to the bobbin body and the bobbin protrusion.

The first end of the ground terminal integrally formed with the bobbin may extend from the bobbin body, and the second end of the ground terminal integrally formed with the bobbin may extend from the bobbin protrusion.

The valve assembly may comprise a valve core having an inlet and an outlet, a valve dome configured to seal one end of the valve core, an armature configured to move forward or backward inside the valve dome, and a plunger configured to open or close the inlet of the valve core as the armature moves forward or backward.

According to one aspect of the present disclosure, there is provided a method of assembling a solenoid valve comprising: winding a coil on a bobbin, wherein a ground terminal is integrally formed with the bobbin; forming a coil assembly by joining the bobbin on which the coil is wound with a housing; joining the coil assembly to a circuit board; and joining a valve assembly to the coil assembly joined with the circuit board.

The ground terminal may be formed integrally with the bobbin through insert injection.

The ground terminal may be formed in a pin shape on the bobbin.

A first end of the ground terminal may be in contact with the valve assembly.

A second end of the ground terminal may be coupled to a ground terminal of the circuit board.

The joining of the coil assembly may comprise couple the coil assembly and the circuit board through a press fit.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a view illustrating a structure of a solenoid valve for a brake system according to an embodiment.

FIG. 2 is a view illustrating a grounding terminal integrally formed with a bobbin of a solenoid valve according to an embodiment.

FIGS. 3A to 3C are diagrams illustrating a shape of the grounding terminal according to an embodiment.

FIG. 4 is a diagram illustrating a shape of the grounding terminal according to an embodiment.

FIG. 5 is a view illustrating a valve assembly of a solenoid valve according to an embodiment.

FIG. 6 is a flowchart illustrating a method for assembling the solenoid valve according to an embodiment.

### DETAILED DESCRIPTION OF THE EMBODIMENT

Hereinafter, the exemplary embodiment of the present disclosure will be described with reference to the accompanying drawings and exemplary embodiments as follows. Scales of components illustrated in the accompanying drawings are different from the real scales for the purpose of description, so that the scales are not limited to those illustrated in the drawings.

Like reference numerals refer to like elements throughout the specification. The present specification does not describe all elements of the embodiments, and any content that is general in the technical field to which the present disclosure belongs or that overlaps between the embodiments is omitted. The terms “portion, module, element, or block” used in the specification may be implemented in software or hardware, and according to the embodiments, a plurality of “portions, modules, elements, or blocks” may be implemented as a single element, or a single “portion, module, element, or block” can include a plurality of elements.

Throughout the specification, when a part is said to be “connected” to another part, this includes not only direct connection but also indirect connection, and indirect connection includes connection via a wireless communications network.

Additionally, when a part is said to “include” a component, this does not mean that it excludes other components, unless otherwise specifically stated, but rather that it may include other components.

Throughout the specification, when it is said that an element is located “on” another element, this includes not only cases where an element is in contact with another element, but also cases where another element exists between the two elements.

The terms first, second, and the like are used to distinguish one component from another, and the components are not limited by the aforementioned terms.

Singular expressions include plural expressions unless the context clearly indicates otherwise.

The identification codes in each step are used for convenience of explanation and do not describe the order of each step. Each step may be performed in a different order than specified unless the context clearly indicates a specific order.

The solenoid valve automatically opens and closes the valve using the electromagnetic force of the electromagnetic coil and is installed in the modulator block and can selectively open and close the flow path formed in the modulator block.

In order to implement the brake system of the vehicle, a plurality of solenoid valves, which are electronically controlled, may be installed in the brake control unit.

Solenoid valves may be classified into a normal open type that maintains a normal open state and a normal close type that maintains a normal closed state.

An embodiment of the present disclosure is to provide each solenoid valve of a brake system, and more specifically, to provide a solenoid valve of a new structure in which a ground terminal is integrated with a bobbin.

Hereinafter, the operating principle and embodiments of the present disclosure will be described with reference to the attached drawings.

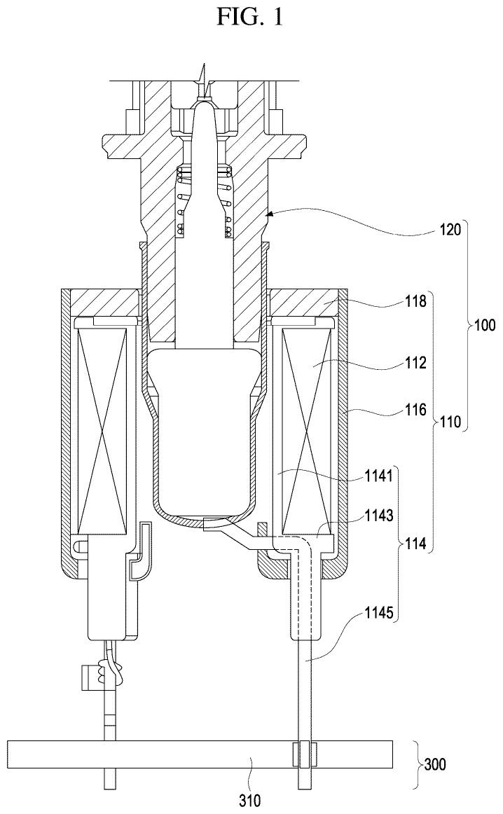

FIG. 1 is a view illustrating a structure of a solenoid valve for a brake system according to an embodiment.

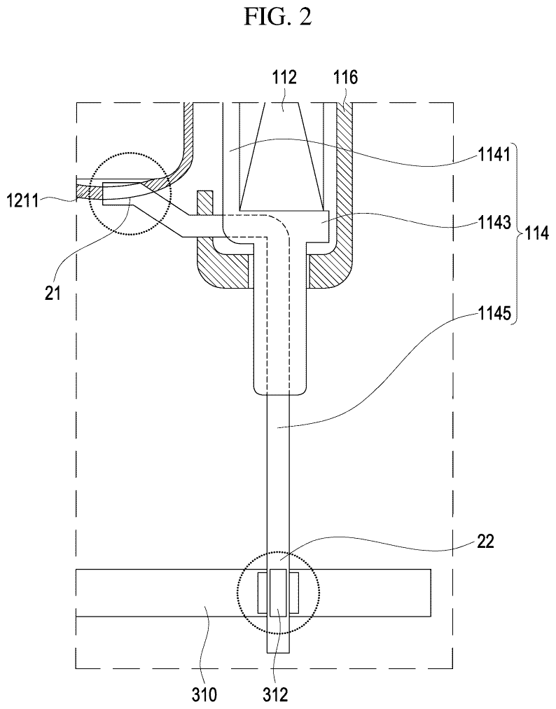

FIG. 2 is a view illustrating a grounding terminal integrally formed with a bobbin of a solenoid valve according to an embodiment.

Referring to FIG. 1, the solenoid valve 100 may be connected to the circuit board 310 of an electric control unit (ECU) 300 through a ground terminal 1145 formed in the solenoid valve 100.

The solenoid valve 100 may include a coil assembly 110 and a valve assembly 120.

The coil assembly 110 has a cylindrical shape with a center formed through it, and may include a bobbin 114 in which the coil 112 is wound around a circumferential surface to generate electromagnetic force by applied power.

The coil 112 has magnetism by generating a magnetic field when electricity flows through it, and accordingly, the electric energy is converted into magnetic energy to move a component such as a flinger of the valve assembly 120.

In addition, the coil assembly 110 may include housings 116 and 118 (also referred to as cases) that are coupled to surround the bobbin 114, and each housing 116 and 118 may be a metal component.

The bobbin 114 may be made of plastic and manufactured through an injection molding process.

The bobbin 114 may include a bobbin body 1141 formed in a hollow disc shape and a bobbin protrusion 1143 formed to protrude by extending from the lower side of the bobbin body 1141.

The bobbin 114 may be provided with a grounding terminal 1145 formed integrally with the bobbin 114.

The grounding terminal 1145 may be formed in a pin-shaped metal and may be integrated with the bobbin 114, and may also be referred to as a grounding pin.

For example, the grounding terminal 1145 and the bobbin 114 can be integrated by applying various conventional techniques such as insert molding or overmoldimg.

For example, the grounding terminal 1145 may protrude in a direction in which the valve assembly 120 is inserted and seated. For example, when the coil assembly 110 and the valve assembly 120 are coupled, the grounding terminal 1145 may protrude in a lateral direction in which a lower portion of the valve assembly 120 is disposed.

Furthermore, when the coil assembly 110 and the circuit board 310 of the electronic control unit 300 are coupled, the ground terminal 1145 may protrude in a direction toward the circuit board 310, that is, to the lower side of the bobbin 114.

The grounding terminal 1145 may be integrally formed to be continuously connected to the bobbin body 1141 and the bobbin protrusion 1143, and may protrude in a lateral direction in which a lower portion of the valve assembly 120 is disposed through the bobbin body 1141 and the bobbin protrusion 1143, and may protrude in a direction toward the circuit board 310.

Referring to FIG. 2, the first end 21 of the grounding terminal 1145 may extend from the bobbin body 1141 and may be connected to the valve assembly 120. The second end 22 of the grounding terminal 1145 may extend from the bobbin protrusion 1143 and may be connected to the circuit board 310 of the electronic control unit 300.

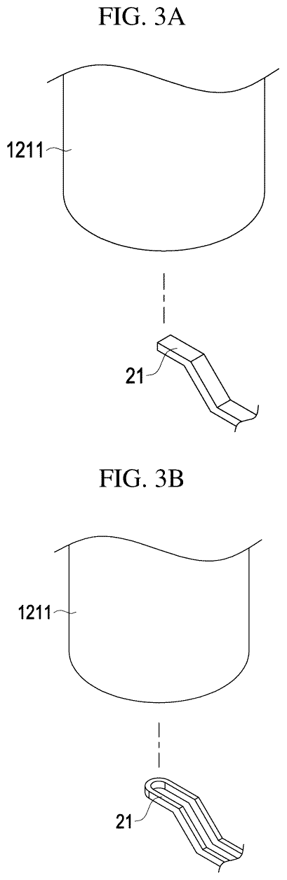

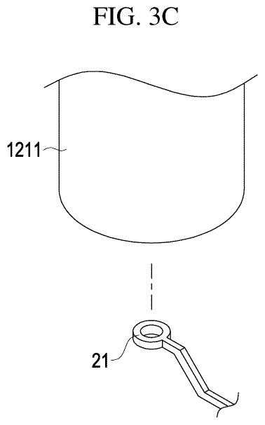

For example, when assembling a hydraulic control unit (HCU) block, the first end 21 of the ground terminal 1145 may be connected to the housing 1211 (also referred to as an outer metal part) (the valve dome (1211 of FIGS. 3A-3C) of the valve assembly 120 of the hydraulic control unit (HCU) block.

As the contact area between the ground terminal 1145 and the valve assembly 120 is increased, the stability of the electrical connection is improved.

Accordingly, the first end 21 of the ground terminal 1145 in contact with the valve assembly 120 may be manufactured in various forms as shown in FIGS. 3A-3C, thereby increasing a contact area of the valve assembly 120 with the housing 1211.

FIGS. 3A to 3C are diagrams illustrating a shape of the grounding terminal according to an embodiment.

Referring to FIG. 3A, the first end 21 of the ground terminal 1145 is formed in a rod shape extending in a horizontal direction, so that a rod-shaped surface extending in the horizontal direction may contact the surface of the housing 1211 of the valve assembly 120.

Referring to FIG. 3B, the first end 21 of the grounding terminal 1145 is formed in a curved shape in a horizontal direction, for example, in a curved U shape, so that the surface of the U shape can come into contact with the surface of the housing 1211 of the valve assembly 120.

Referring to FIG. 3C, the first end 21 of the grounding terminal 1145 is formed in a ring shape in a horizontal direction, so that the surface of the ring shape can come into contact with the surface of the housing 1211 of the valve assembly 120.

An effect of improving the stability of the electrical connection is achieved as the conductivity of the grounding terminal 1145 increases.

Accordingly, the first end 21 of the grounding terminal 1145 that comes into contact with the valve assembly 120 may be manufactured by being plated with a material having high electrical conductivity. For example, one end 21 of the grounding terminal 1145 may be plated with gold or silver.

The second end 22 of the grounding terminal 1145 may be connected to a grounding point 312 (or also called a ground pad) of the circuit board 310.

For example, when the bobbin 114 and the circuit board 310 are coupled, the grounding terminal 1145 may be in a form that extends in a straight line from the bobbin 114 to the circuit board 310 as shown in FIGS. 1 and 2.

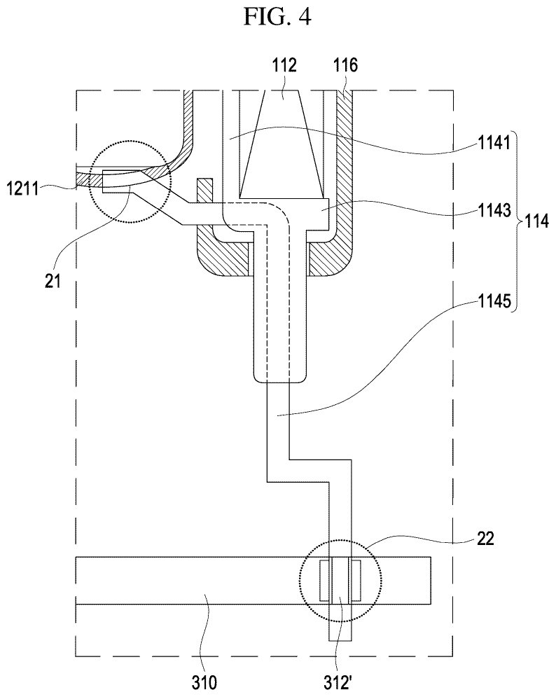

As another example, the grounding terminal 1145 may be formed in a partially bent shape as shown in FIG. 4.

FIG. 4 is a diagram illustrating a shape of the grounding terminal according to an embodiment.

Referring to FIG. 4, the grounding terminal 1145 is formed in a bent shape and when the bobbin 114 and the circuit board 310 are connected, the grounding terminal 1145 may be formed to extend in a straight line from the bobbin 114 toward the circuit board 310, then extend in a horizontal direction, and then extend in a straight line to the circuit board 310.

The shape of the ground terminal 1145 as described above may allow the ground point 312′ on the circuit board 310 coupled to the second end 22 of the ground terminal 1145 to be arranged at various positions.

The grounding terminal 1145 may be connected to and coupled to the circuit board 310 and the valve assembly 120 through a press-fit, a soldering or the like. In addition, one of various conventional fixing techniques can be applied to connect the grounding terminal 1145 to the circuit board 310 and the valve assembly 120.

Since the ground terminal 1145 is connected and coupled to the valve assembly 120 and the circuit board 310 of the electronic control unit 300, the ground terminal 1145 may block or induce electromagnetic interference occurring in one or more of the signal line and the power line of the electronic control unit 300 to reduce noise.

The housings 116 and 118 may accommodate the bobbin 114 and may be coupled to the bobbin 114 to surround an outer side of the bobbin 114.

The housing 116 may have a cylindrical shape with an open top and may be referred to as an outer housing. The lower surface of the housing 116 may be formed so that a portion of the lower side of the bobbin 114 may pass therethrough. For example, the lower surface of the housing 116 may be formed so that the bobbin protrusion 1143 may pass therethrough.

The housing 118 may cover the opening of the outer housing 116 in a state in which the bobbin 114 is accommodated and coupled to the outer housing 116, and the housing 118 may also be referred to as an outer housing.

The valve assembly 120 may open and close the internal flow path by an electromagnetic field formed in the coil assembly 110.

The valve assembly 120 includes a configuration in which a plunger is built so as to open and close an orifice, and one of the various conventional valve assembly configurations may be applied.

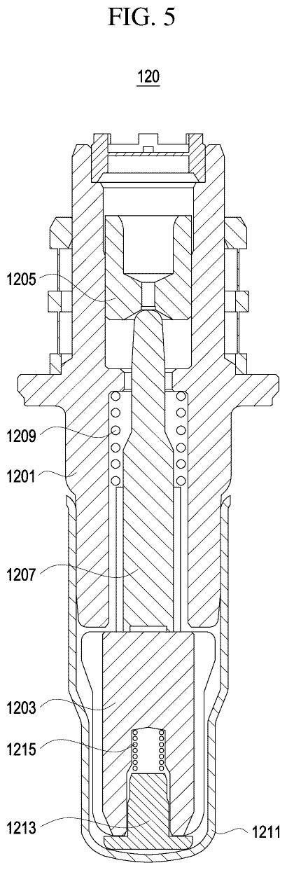

FIG. 5 is a view illustrating a valve assembly of a solenoid valve according to an embodiment.

Referring to FIG. 5, the valve assembly 120 includes the valve core 1201, the armature 1203 provided at the upper end of the valve core 1201, the valve seat 1205 provided at the lower end of the valve core 1201, the plunger 1207 interposed between the valve core 1201 and the valve seat 1205, the return spring 1209 interposed between the plunger 1207 and the valve seat 1205, and a cylindrical valve dome 1211 surrounding the side surface of the valve core 1201 and the upper side of the armature 1203, and a buffer member 1213 and/or a damping spring 1215 between the valve dome 1211 and the armature 1203.

The valve core 1201 is a configuration that forms the body of the valve assembly 120, and has a longitudinal through hole formed in the center and an inlet and outlet provided at the bottom for the inflow and discharge of oil.

The valve dome 1211 is formed in a thin cylindrical shape and surrounds the upper part of the valve core 1201 to seal one end of the valve core 1201.

The armature 1203 is provided in a longitudinal direction inside the valve dome 1211 and is installed in a cylindrical shape so as to move forward and backward for a predetermined section. A cylindrical excitation coil (not shown), which receives power to drive the armature 1203 forward and backward, is mounted around and coupled to the outer surface of the valve dome 1211.

The plunger 1207 is disposed in the inner through hole of the valve core 1201, and is provided in the shape of a rod capable of moving forward and backward in the longitudinal direction. The plunger 1207 is disposed so that one end thereof is adjacent to the valve seat 1205 installed at the inlet of the valve core 1201, and the other end thereof is disposed so as to be adjacent to the armature 1203.

The inlet of the valve core 1201 is opened and closed according to the forward and backward movement of the armature 1203. At this time, an end portion of the plunger 1207 adjacent to the valve seat 1205 may have a round shape or a separate sphere coupled to block the flow path of the valve seat 1205 when the plunger 1207 moves forward by the operation of the armature 1203, for example, to block an orifice provided on the valve seat 1205 and block the flow of oil.

The return spring 1209 is disposed between the valve core 1201 and the plunger 1207 through which the plunger 1207 passes. One end of the return spring 1209 may be supported on a stepped portion close to the valve seat 1205 and may also be directly supported on the valve seat 1205. The other end of the return spring 1209 may be supported by being partially fitted into the end of the plunger 1207 and may also be supported on the stepped portion provided on the plunger 1207.

The buffer member 1213 may be provided between the armature 1203 and the valve dome 1211 to reduce vibration and noise generated when the armature 1203 moves forward and backward and collides with the valve dome 1211.

Meanwhile, the valve assembly 120 may be coupled to the coil assembly 110 so that the circuit board 310 and the valve dome 1211 of the valve assembly 120 face each other as shown in FIG. 1.

Furthermore, at least a portion of the outer side of the valve dome 1211 of the valve assembly 120 may be made of metal.

Accordingly, the other end of the ground terminal 1145 formed in the bobbin 114 of the coil assembly 110 may be connected to the metal part of the valve dome 1211.

The electronic control unit 300 may control the valve assembly 120 and may open and close a flow path supplied to the wheel side of the vehicle or control the driving of the hydraulic pump to enable intermittent braking of the corresponding wheel through the return flow path. For example, the electronic control unit 300 may control the valve assembly 120 by supplying a voltage to the connected coil 112.

The electronic control unit 300 may include a circuit board 310.

For example, a micro control unit (MCU) and/or various devices may be mounted on the circuit board 310.

For example, the circuit board 310 may be a printed circuit board (PCB).

In the embodiment described above, the shape of the first end (21) of the ground terminal 1145 that comes into contact with the valve assembly 120 can be changed to various shapes that can increase the contact area with the valve assembly 120 in addition to the shape of the embodiment of FIGS. 3A-3C described above.

For example, the first end 21 of the grounding terminal 1145 in the embodiment can be formed in a shape corresponding to the lower side of the valve assembly 120 so that it can come into surface contact with the lower side of the valve assembly 120 that comes into contact with it.

In addition, it was explained that the first end 21 of the ground terminal 1145 in contact with the valve assembly 120 in the above-described embodiment was plated with a material with high electrical conductivity.

However, according to another embodiment, the first end 21 of the ground terminal 1145 may be a combination or attachment of an additional terminal of a material with high electrical conductivity.

In addition, in the above-described embodiment, the ground terminal 1145 is formed in a straight line or in a bent shape from the bobbin 114 to the circuit board 310, that is, it is described as extending straight from the bobbin 114 toward the circuit board 310, then extending horizontally, and then extending straight to the circuit board 310.

However, in addition to the shape between the bobbin 114 and the circuit board 310 of the ground terminal 1145 in the above-described embodiment, it can be applied in various shapes.

For example, a part of the ground terminal 1145 extending from the bobbin 114 to the circuit board 310 may be bent in an arc shape.

Meanwhile, the solenoid valve according to the above-described embodiments can solve problems or disadvantages that may arise according to the characteristics of the ground structure provided in the conventional solenoid valve.

For example, one of the two grounding techniques has been applied to conventional solenoid valves.

The first of the two ground technologies is that the ground is provided in the housing of the solenoid valve to contact the printed circuit board and the solenoid valve.

The first method has a disadvantage in that it requires assembly man-hours and reduces grounding performance due to the small contact area.

In addition, the second of the two ground technologies is a method in which the ground is mounted on the printed circuit board through Surface Mount Technology (SMT) to contact the printed circuit board and the solenoid valve.

The second method takes up a lot of space in the printed circuit board, and it may be necessary to move the ground position and add the ground part to secure electromagnetic compatibility (EMC) performance.

However, in the case of the second method, there has been a problem that it is difficult to move and add the grounding location after the design of the printed circuit board is completed.

The second method, which is widely applied in the assembly of conventional solenoid valves, adopts a process in which the ground terminal is first mounted on the circuit board, then the circuit board with the mounted ground terminal is coupled to the valve assembly, and afterward, the coil assembly is coupled to the valve assembly that has been combined with the circuit board.

On the other hand, the solenoid valve according to the above-described embodiments of the present disclosure solves the disadvantages and problems of the first and second methods described above by forming the ground terminal to be integrated with the bobbin.

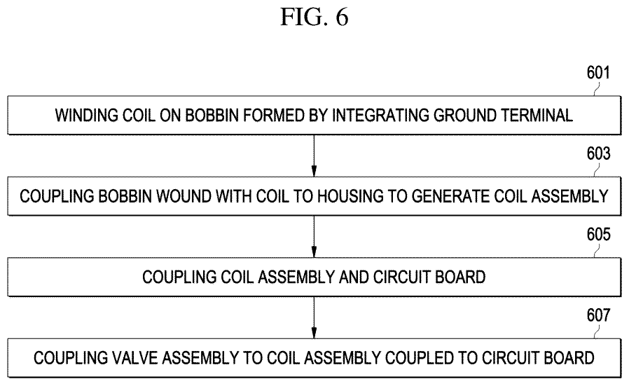

For example, in the above-described embodiment, since the ground terminal 1145 is formed to be integrated with the bobbin 114, the assembly of the solenoid valve 100 according to the above-described embodiment can be performed without the assembly process of mounting the conventional grounding terminal on the circuit board, as shown in the following FIG. 6.

FIG. 6 is a flowchart illustrating a method for assembling the solenoid valve according to an embodiment.

Referring to FIG. 6, Step 601 is winding the coil 112 on the bobbin 114 formed by integrating the ground terminal 1145.

The grounding terminal 1145 may be integrated with the bobbin 114 through insert injection.

For example, the grounding terminal 1145 may be integrated with the bobbin 114 in a pin shape.

In addition, the bobbin 114 may be provided with a signal terminal (not shown). For example, the signal terminal may be formed integrally with the bobbin 114 like the ground terminal 1145, or may be coupled (or referred to as attachment) to the bobbin 114.

Step 603 is coupling the bobbin 114 wound with the coil 112 to the housings 116 and 118 to generate the coil assembly 110.

Step 605 is coupling the coil assembly 110 and the circuit board 310 (605).

For example, the coil assembly 110 and the circuit board 310 may be coupled through a press fit.

Step 607 is coupling the valve assembly 120 to the coil assembly 110 coupled to the circuit board 310.

For example, the valve assembly 120 may be coupled to the coil assembly 110 through a press fit.

Through the combination of the coil assembly 110 and the valve assembly 120 in the above-described embodiment of FIG. 6, the first end of the ground terminal 1145 may contact the valve assembly 120.

In addition, the second end of the ground terminal 1145 may be combined with the ground terminal of the circuit board 310 through the combination of the coil assembly 110 and the circuit board 310 in the above-described embodiment of FIG. 6.

The assembly method of the solenoid valve 100 according to the embodiment of FIG. 6 is more efficient than the conventional solenoid valve assembly method in that it reduces assembly man-hours.

For example, in the case of a solenoid valve according to the prior art, assembly man-hours are required and dimensional management is necessary, whereas the solenoid valve according to the above-described embodiment of the present disclosure requires neither assembly man-hours nor dimensional management.

In addition, the solenoid valve 100 according to the above-described embodiment of the present disclosure can improve the stability of the electrical connection of the grounding terminal.

For example, the solenoid valve 100 according to an embodiment of the present disclosure can be implemented with a structure that increases the coupling area of the ground terminal 1145 coupled to the valve assembly 120.

In addition, the solenoid valve 100 according to an embodiment of the present disclosure can be configured using a material that improves the electrical conductivity of the grounding terminal 1145 coupled to the valve assembly 120.

In addition, the solenoid valve 100 according to an embodiment of the present disclosure has the advantage of simplified installation, as the spring and coil are formed as an integrated unit.

Furthermore, according to the above-described embodiments of the present disclosure, the layout of the printed circuit board can be more easily secured, and its positioning is more flexible.

For example, the solenoid valve according to the above-described embodiment of the present disclosure only requires securing a grounding point (also referred to as a hole) on the printed circuit board where a grounding pin can be assembled. As a result, compared to conventional surface mount technology (SMT)-based springs, it requires less component mounting space and allows the grounding pin to be installed anywhere around the coil.

The solenoid valve and the assembly method thereof according to the above-described embodiments may simplify the assembly of the solenoid valve by integrating the ground terminal with the bobbin of the solenoid coil.

For example, it can provide a new technology for assembling solenoid valves without the assembly process of mounting the ground terminal on the circuit board in the conventional solenoid valve assembly method.

For example, in the case of a solenoid valve according to the prior art, assembly man-hours and dimensional management are required, whereas the solenoid valve according to the disclosed invention does not require such assembly man-hours or dimensional management.

The solenoid valve and the assembly method thereof according to the above-described embodiments may allow for easy securing of space on the circuit board, facilitate positioning of the ground terminal on the circuit board, and enable changes in the position of the ground terminal.

For example, in the case of the solenoid valve according to the above-described embodiments, only a ground point where the ground terminal can be assembled on the circuit board needs to be secured. Therefore, compared to the prior art, the required component mounting space is reduced, and a ground point can be provided anywhere on the circuit board, thereby increasing the flexibility in the arrangement of the ground terminal.

The solenoid valve according to the above-described embodiments can couple the ground terminal to the circuit board by press-fit, soldering, or the like, thereby ensuring a stable electrical connection.

The disclosed embodiments have been described with reference to the attached drawings as described above. Those skilled in the art will understand that the present disclosure can be implemented in forms other than the disclosed embodiments without changing the technical idea or essential features of the present disclosure. The disclosed embodiments are exemplary and should not be construed as limiting.

What is claimed is:

1. A solenoid valve comprising:
a bobbin having a wound coil and a ground terminal, wherein the ground terminal is integrally formed with the bobbin; and
a valve assembly configured to open or close a flow path by magnetic field generated by the wound coil, wherein a first end of the ground terminal is configured to be in contact with the valve assembly.

2. The solenoid valve according to claim 1, wherein the ground terminal integrally formed with the bobbin is formed in a pin shape on the bobbin.

3. The solenoid valve according to claim 1, wherein the first end of the ground terminal integrally formed with the bobbin is plated with gold or silver.

4. The solenoid valve according to claim 1, wherein one side of the first end of the ground terminal integrally formed with the bobbin has a linear shape, a curved shape, or a ring shape.

5. The solenoid valve according to claim 1, further comprising:
a circuit board configured to supply current to the wound coil.

6. The solenoid valve according to claim 5, wherein a second end of the ground terminal integrally formed with the bobbin is coupled to the circuit board.

7. The solenoid valve according to claim 6, wherein the second end of the ground terminal integrally formed with the bobbin is coupled to a ground terminal of the circuit board through press-fit or soldering.

8. The solenoid valve according to claim 7, wherein the ground terminal integrally formed with the bobbin extends in a straight line from the bobbin to the circuit board.

9. The solenoid valve according to claim 7, wherein the ground terminal integrally formed with the bobbin extends in a first straight line from the bobbin toward the circuit board, then extends in a horizontal direction, and then extends in a second straight line from the bobbin to the circuit board.

10. The solenoid valve according to claim 6, wherein the bobbin comprises a bobbin body having a hollow disk shape, and a bobbin protrusion configured to protrude by extending from a lower side of the bobbin body.

11. The solenoid valve according to claim 10, further comprising:
a housing in which the bobbin is accommodated, wherein a lower surface of the housing is configured to be penetrated by the bobbin protrusion.

12. The solenoid valve according to claim 11, wherein the ground terminal integrally formed with the bobbin is integrally formed by being continuously connected to the bobbin body and the bobbin protrusion.

13. The solenoid valve according to claim 12, wherein the first end of the ground terminal integrally formed with the bobbin extends from the bobbin body, and the second end of the ground terminal integrally formed with the bobbin extends from the bobbin protrusion.

14. The solenoid valve according to claim 1, wherein the valve assembly comprises:
a valve core having an inlet and an outlet,
a valve dome configured to seal one end of the valve core,
an armature configured to move forward or backward inside the valve dome, and
a plunger configured to open or close the inlet of the valve core as the armature moves forward or backward.

15. A method of assembling a solenoid valve comprises:
winding a coil on a bobbin, wherein a ground terminal is integrally formed with the bobbin;
forming a coil assembly by joining the bobbin on which the coil is wound with a housing;
coupling the coil assembly to a circuit board; and
coupling a valve assembly to the coil assembly coupled to the circuit board.

16. The method according to claim 15, wherein the ground terminal is formed integrally with the bobbin through insert injection.

17. The method according to claim 16, wherein the ground terminal is formed in a pin shape on the bobbin.

18. The method according to claim 17, wherein a first end of the ground terminal is in contact with the valve assembly.

19. The method according to claim 18, wherein a second end of the ground terminal is coupled to a ground terminal of the circuit board.

20. The method according to claim 15, wherein the coupling of the coil assembly comprises:
coupling the coil assembly and the circuit board through a press fit.
